(19) United States
(12) Patent Application Publication
(10) Pub. No.: US 2017/0161136 A1
(43) Pub. Date: Jun. 8, 2017

(54) SYSTEM STATE DETECTION METHOD AND SYSTEM AND SERVER

(71) Applicants: INVENTEC TECHNOLOGY CO., LTD, Shanghai (CN); INVENTEC CORPORATION CO., LTD, Taibei City (TW)

(72) Inventor: Yingxian HAN, Shanghai (CN)

(73) Assignees: INVENTEC TECHNOLOGY CO., LTD, Shanghai (CN); INVENTEC CORPORATION CO., LTD, Taibei City (TW)

(21) Appl. No.: 15/256,382

(22) Filed: Sep. 2, 2016

(30) Foreign Application Priority Data
Dec. 4, 2015 (CN) 201510887789.1

(51) Int. Cl. G06F 11/07

(52) U.S. Cl. CPC G06F 11/0769; G06F 11/0706; G06F 11/0751

(57) ABSTRACT

A system state detection method, including: reading a current fault event related to a system state through a complex programmable logic device; judging whether the current fault event has already pre-stored in a desktop server or not through the complex programmable logic device; if so, executing a next step; if not, dividing the current fault event into a corresponding fault priority; and searching a fault priority corresponding to the current fault event through the complex programmable logic device, and lighting up an LED health lamp matched with the corresponding fault priority in a preset alarming manner according to the corresponding fault priority.

### BACKGROUND OF THE INVENTION

Field of Invention

The invention belongs to the technical field of computers, and relates to a detection method and system, in particular to a system state detection method and system and a server.

Description of Related Arts

A server generally has standard components such as a complete case, a power supply, a mainboard and memories. Regardless of an HP server or other servers, a baseboard management controller (BMC) chip is provided and system state information is displayed on health lamps on a panel through the BMC.

The development of the existing servers and storage devices changes quickly, new techniques and new products emerge one after another, faults are exceedingly strange, and in the most common hardware faults such as computer shutdown and system blue screen, parts such as hardware, a mainboard, internal memories and data lines may cause the faults. For users and even technical service personnel, it is usually difficult to accurately judge these faults, a mode of operating scan chain or xregister through the BMC is needed to realize the whole-day feedback of the system state, the state information needs to be displayed on heath lamps and thus the display of the state information cannot be separated from the support of the BMC. However, for some customized types, such as a desktop server, the BMC is not arranged in consideration of the cost but basic functions which can be realized by the BMC still need to be reserved.

Therefore, how to provide a system state detection method and system and a server has already indeed become a technical problem to be urgently solved by one skilled in the art in order to satisfy the customer demands of still realizing the basic functions of the BMC without using the BMC.

### SUMMARY OF THE INVENTION

In view of the above-mentioned disadvantages of the prior art, the purpose of the invention is to provide a system state detection method and system and a server, which are used for satisfying the customer demands of still realizing the basic function of a BMC without using the BMC in the prior art.

In order to realize the above-mentioned and other related purposes, in one aspect, the invention provides a system state detection method, which is applied to a desktop server and comprises the following steps: reading a current fault event related to a system state through a complex programmable logic device; judging whether the current fault event has already been pre-stored in the desktop server or not through the complex programmable logic device; if so, executing a next step; and if not, dividing the current fault event into a corresponding fault priority; and searching a fault priority corresponding to the current fault event through the complex programmable logic device, and lighting up an LED health lamp matched with the corresponding fault priority in a preset alarming manner according to the corresponding fault priority.

In one embodiment of the invention, the fault priority comprises a first fault priority including faults which are related to system state powering-on; a second fault priority including faults which occur during operation of system processes; a third fault priority including faults which are related to system hardware heat dissipation and cause system shutdown; and a fourth fault priority including faults which are related to system hardware heat dissipation and in which a system still keeps on operating.

In one embodiment of the invention, fault events corresponding to the first fault priority comprise an internal memory power supply fault event, a processor power supply fault event and/or a processor power supply control error fault event; and when one or more of fault events corresponding to the first fault priority occur, a red lamp of the LED health lamps flashes at frequency of 4 Hz.

In one embodiment of the invention, fault events corresponding to the second fault priority comprise fault events related to processor reports and the system processes; and when the fault events related to the processor reports and the system processes occur, the red lamp of the LED health lamps is normally lighted up.

In one embodiment of the invention, fault events corresponding to the third fault priority comprise a system fan fault event, a system temperature sensor overheating fault event and/or a processor primary overheating fault event; and when one or more of the fault events corresponding to the third fault priority occur, a yellow lamp of the LED health lamps flashes at frequency of 1 Hz.

In one embodiment of the invention, fault events corresponding to the fourth fault priority comprise a processor power supply overheating fault event and/or a processor secondary overheating fault event; and when one or more of the fault events corresponding to the fourth fault priority occur, the yellow lamp of the LED health lamps is normally lighted up.

In another aspect, the invention further provides a system state detection system, which is applied to a desktop server and comprises a reading module used for reading a current fault event related to a system state; a processing module connected with the reading module and used for judging whether the current fault event has already been pre-stored in the desktop server or not; if so, calling a searching module for searching a fault priority corresponding to the current fault event and an operation module for lighting up an LED health lamp matched with the corresponding fault priority in a preset alarming manner according to the corresponding fault priority; and if not, calling a dividing module for dividing the current fault event into the corresponding fault priority.

In one embodiment of the invention, the system state detection system further comprises a storage module connected with the dividing module, and the storage module is used for storing the current fault event after the current fault event is divided into the corresponding fault priority.

In another aspect, the invention further provides a server, which comprises the system state detection system.

In one embodiment of the invention, the server is a desktop server.

As described above, the system state detection method and system and the server provided by the invention have the following beneficial effects:

The system state detection method and system and the server provided by the invention do not need to use the BMC chip to support the display of state information, realize the detection of the entire system state, tell the position of the problem to the user or the tester through different colors of health lamps and how to solve it, thus greatly improve the system working efficiency and satisfy the demands of various customers.

### BRIEF DESCRIPTION OF THE DRAWINGS

FIG. 1 illustrates a flowchart of a system state detection method of the invention in one embodiment.

FIG. 2 illustrates a principle and structure schematic diagram of a system state detection system of the invention in one embodiment.

FIG. 3 illustrates a principle and structure schematic diagram of a server of the invention in one embodiment.

### DESCRIPTION OF COMPONENT MARK NUMBERS

1 System state detection system
11 Reading module
12 Processing module
13 Searching module
14 Operation module
15 Dividing module
16 Storage module
2 Server
S1-S6 Steps

### DETAILED DESCRIPTION OF THE PREFERRED EMBODIMENTS

The implementation mode of the invention will be described below through specific embodiments. One skilled in the art can easily understand other advantages and effects of the invention according to contents disclosed by the description. The invention can also be implemented or applied through other different specific implementation modes. Various modifications or changes can also be made to all details in the description based on different points of view and applications without departing from the spirit of the invention. It needs to be stated that the following embodiments and the features in the embodiments can be combined with one another under the situation of no conflict.

It needs to be stated that the drawings provided in the following embodiments are just used for schematically describing the basic concept of the invention, thus only illustrate components only related to the invention and are not drawn according to the numbers, shapes and sizes of components during actual implementation, the configuration, number and scale of each component during actual implementation thereof may be freely changed, and the component layout configuration thereof may be more complex.

### Embodiment 1

This embodiment provides a system state detection method, which is applied to a desktop server and comprises the following steps:

reading a current fault event related to a system state through a complex programmable logic device;

judging whether the current fault event has already been pre-stored in the desktop server or not through the complex programmable logic device; if so, executing a next step; and if not, dividing the current fault event into a corresponding fault priority; and

searching a fault priority corresponding to the current fault event through the complex programmable logic device, and lighting up an LED health lamp matched with the corresponding fault priority in a preset alarming manner according to the corresponding fault priority.

The system state detection method provided by this embodiment will be described in details in combination with the drawings. The system state detection method is applied to a desktop server. The system state detection method is based on the feature that the desktop server does not have a BMC, and can also realize the display of system state information on health lamps through CPLD code design without adopting the management of the BMC chip to remind a user to perform corresponding maintenance and detection.

Please refer to FIG. 1, which illustrates a flowchart of a system state detection method of the invention in one embodiment. As shown in FIG. 1, the system state detection method specifically comprises the following steps:

S1: reading a current fault event related to a system state through a complex programmable logic device (CPLD). The complex programmable logic device (CPLD) is a device which is developed from PAL and GAL devices, belongs to the range of large-scale integrated circuits and is a digital integrated circuit that a user can self-construct logic functions according to the needs thereof. The basic design method thereof is to generate a corresponding object file by virtue of an integrated development software platform by using methods such as schematic diagrams and hardware description languages, and transmit a code, i.e., a CPLD code to a target chip through a downloading cable (“on-system” programming) to realize a designed digital system. In this embodiment, the CPLD mainly consists of programmable logic macro cells which surround a programmable interconnection matrix unit in a center, wherein an MC structure is more complex, has a complex I/O cell interconnection structure, and can generate a specific circuit structure according to the needs of the user to complete the function of detecting the system state.

S2: judging whether the current fault event has already been pre-stored in the desktop server or not through the complex programmable logic device; if so, executing step S3; and if not, executing step S4. In this embodiment, each fault event has a corresponding fault priority and the fault priority comprises a first fault priority including faults which are related to system state powering-on; a second fault priority including faults which occur during operation of system processes; a third fault priority including faults which are related to system hardware heat dissipation and cause system shutdown; and a fourth fault priority including faults which are related to system hardware heat dissipation and in which a system still keeps on operating. In this embodiment, the first fault priority is greater than the second fault priority, the first fault priority and the second fault priority are greater than the third fault priority, and the first fault priority, the second fault priority and the third fault priority are greater than the fourth fault priority. Therefore, in this embodiment, the current fault event which has already been pre-stored in the desktop server and is related to the system state is arranged according to the fault priority.

S3: if the current fault event is found in the fault events pre-stored in the desktop server, searching a fault priority corresponding to the current fault event through the complex programmable logic device.

Fault events corresponding to the first fault priority including the faults which are related to system state powering-on are called as first fault events. In this embodiment, the first fault events comprise an internal memory power supply fault event, a processor power supply fault event and/or a processor power supply control error fault event. For example, the first fault events comprise:

A1: PGD_P0V6_VTT_DIMM;

B1: PGD_P2V5_M0_AB_VPP;

C1: PGD_PVCC_VCCIO;

D1: PGD_PVCCIN_CPU;

E1: PGD_PVDDQ_CPU_AB_DDR4; and/or

F1: PVCCIN Fault: PAL_VR_FAULT_PVCCIN_CPU.

Fault events corresponding to the second fault priority including the faults which occur during the operation of the system processes are called as second fault events. In this embodiment, the second fault events comprise fault events related to processor reports and the system processes. For example, the second fault events comprise PAL_CPU_CATERR, link to high trigger.

Fault events corresponding to the third fault priority including the faults which are related to system hardware heat dissipation and cause system shutdown are called as third fault events. The fault events corresponding to the third fault priority comprise a system fan fault event, a system temperature sensor overheating fault event and/or a processor primary overheating fault event. For example, the third fault events comprise:

A3: HW_MONITOR_SMBALERT;

B3: PAL_EMC_ALERT_N;

C3: PAL_EMC_THERM_N; and/or

D3: PAL_CPU_THERMTRIP_N.

In this embodiment, the processor primary overheating fault event refers to that the temperature of a processor is detected to exceed a preset first overheating threshold.

Fault events corresponding to the fourth fault priority including the faults which are related to system hardware heat dissipation and in which a system still keeps on operating are called as fourth fault events. The fault events corresponding to the fourth fault priority comprise a processor power supply overheating fault event and/or a processor secondary overheating fault event. For example, the fourth fault events comprise:

A4: VR_PVCC_CPU_VR_HOT_N, link to GND trigger;

B4: H_CPU_PROCHOT, link to high trigger; and/or

C4: FM_CPU_DIMM_EVENT_CO_N.

In this embodiment, the processor secondary overheating fault event refers to that the temperature of the processor is detected to exceed a preset second overheating threshold. The first overheating threshold is greater than the second overheating threshold.

S5: lighting up an LED health lamp matched with the corresponding fault priority in a preset alarming manner according to the corresponding fault priority. In this embodiment, the LED health lamps comprise a red lamp, a yellow lamp and a green lamp.

For example, when one or more of fault events corresponding to the first fault priority, i.e., the first fault events occur, the red lamp of the LED health lamps flashes at frequency of 4 Hz.

When the second fault events, i.e., the fault events related to the processor reports and the system processes occur, the red lamp of the LED health lamps is normally lighted up.

When one or more of the fault events corresponding to the third fault priority, i.e., the third fault events occur, the yellow lamp of the LED health lamps flashes at frequency of 1 Hz.

When one or more of the fault events corresponding to the fourth fault priority, i.e., the fourth fault events occur, the yellow lamp of the LED health lamps is normally lighted up.

S4: if the current fault event is not found in the fault events pre-stored in the desktop server, dividing the current fault event into a corresponding fault priority according to the demands of the user through the complex programmable logic device.

S6: storing the current fault event which is not found in the fault events pre-stored in the desktop server through the complex programmable logic device.

The system state detection method provided by the invention does not need to use the BMC chip to support the display of state information, realizes the detection of the entire system state, tells the position of the problem to the user or the tester through different colors of health lamps and how to solve it, thus greatly improves the system working efficiency and satisfies the demands of various customers.

### Embodiment 2

This embodiment provides a system state detection system, which is applied to a desktop server and comprises:

a reading module, used for reading a current fault event related to a system state;

a processing module, connected with the reading module and used for judging whether the current fault event has already been pre-stored in the desktop server or not; if so, calling a searching module for searching a fault priority corresponding to the current fault event and an operation module for lighting up an LED health lamp matched with the corresponding fault priority in a preset alarming manner according to the corresponding fault priority; and if not, calling a dividing module for dividing the current fault event into the corresponding fault priority.

The system state detection system provided by this embodiment will be described in details in combination with the drawings. The system state detection system is applied to a desktop server. The system state detection system is based on the feature that the desktop server does not have a BMC, and can also realize the display of system state information on health lamps through CPLD code design without adopting the management of the BMC chip to remind a user to perform corresponding maintenance and detection.

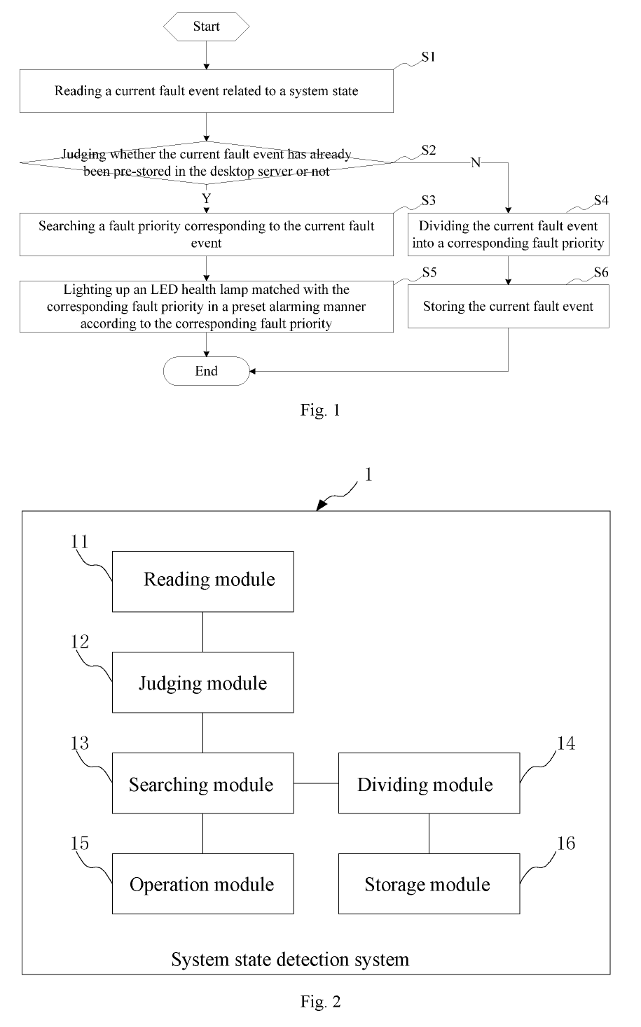

Please refer to FIG. 2, which illustrates a principle and structure schematic diagram of a system state detection system of the invention in one embodiment. As shown in FIG. 2, the system state detection system 1 comprises a reading module 11, a processing module 12, a searching module 13, an operation module 14, a dividing module 15 and a storage module 16.

The reading module 11 is used for reading a current fault event related to a system state.

The processing module 12 which is connected with the reading module 11 is used for judging whether the current fault event has already been pre-stored in the desktop server or not; if so, calling the searching module 13 and the operation module 14; and if not, calling the dividing module 15 and the storage module 16. In this embodiment, each fault event has a corresponding fault priority and the fault priority comprises a first fault priority including faults which are related to system state powering-on; a second fault priority including faults which occur during operation of system processes; a third fault priority including faults which are related to system hardware heat dissipation and cause system shutdown; and a fourth fault priority including faults which are related to system hardware heat dissipation and in which a system still keeps on operating. In this embodiment, the first fault priority is greater than the second fault priority, the first fault priority and the second fault priority are greater than the third fault priority, and the first fault priority, the second fault priority and the third fault priority are greater than the fourth fault priority. Therefore, in this embodiment, the current fault event which has already been pre-stored in the desktop server and is related to the system state is arranged according to the fault priority.

The searching module 13 which is connected with the processing module 12 is used for, if the current fault event is found in the fault events pre-stored in desktop server, searching a fault priority corresponding to the current fault event through the complex programmable logic device.

Fault events corresponding to the first fault priority including the faults which are related to system state powering-on are called as first fault events. In this embodiment, the first fault events comprise an internal memory power supply fault event, a processor power supply fault event and/or a processor power supply control error fault event. For example, the first fault events comprise:

A1: PGD_P0V6_VTT_DIMM;

B1: PGD_P2V5_M0_AB_VPP;

C1: PGD_PVCC_VCCIO;

D1: PGD_PVCCIN_CPU;

E1: PGD_PVDDQ_CPU_AB_DDR4; and/or

F1: PVCCIN Fault: PAL_VR_FAULT_PVCCIN_CPU.

Fault events corresponding to the second fault priority including the faults which occur during the operation of the system processes are called as second fault events. In this embodiment, the second fault events comprise fault events related to processor reports and the system processes. For example, the second fault events comprise PAL_CPU_CATERR, link to high trigger.

Fault events corresponding to the third fault priority including the faults which are related to system hardware heat dissipation and cause system shutdown are called as third fault events. The fault events corresponding to the third fault priority comprise a system fan fault event, a system temperature sensor overheating fault event and/or a processor primary overheating fault event. For example, the third fault events comprise:

A3: HW_MONITOR_SMBALERT;

B3: PAL_EMC_ALERT_N;

C3: PAL_EMC_THERM_N; and/or

D3: PAL_CPU_THERMTRIP_N.

In this embodiment, the processor primary overheating fault event refers to that the temperature of a processor is detected to exceed a preset first overheating threshold.

Fault events corresponding to the fourth fault priority including the faults which are related to system hardware heat dissipation and in which a system still keeps on operating are called as fourth fault events. The fault events corresponding to the fourth fault priority comprise a processor power supply overheating fault event and/or a processor secondary overheating fault event. For example, the fourth fault events comprise:

A4: VR_PVCC_CPU_VR_HOT_N, link to GND trigger;

B4: H_CPU_PROCHOT, link to high trigger; and/or

C4: FM_CPU_DIMM_EVENT_CO_N.

In this embodiment, the processor secondary overheating fault event refers to that the temperature of the processor is detected to exceed a preset second overheating threshold. The first overheating threshold is greater than the second overheating threshold.

The operation module 14 which is connected with the searching module 13 is used for lighting up an LED health lamp matched with the corresponding fault priority in a preset alarming manner according to the corresponding fault priority. In this embodiment, the LED health lamps comprise a red lamp, a yellow lamp and a green lamp.

For example, when one or more of fault events corresponding to the first fault priority, i.e., the first fault events occur, the operation module 14 enables the red lamp of the LED health lamps to flash at frequency of 4 Hz.

When the second fault events, i.e., the fault events related to the processor reports and the system processes occur, the operation module 14 enables the red lamp of the LED health lamps to be normally lighted up.

When one or more of the fault events corresponding to the third fault priority, i.e., the third fault events occur, the operation module 14 enables the yellow lamp of the LED health lamps to flash at frequency of 1 Hz.

When one or more of the fault events corresponding to the fourth fault priority, i.e., the fourth fault events occur, the operation module 14 enables the yellow lamp of the LED health lamps to be normally lighted up.

The dividing module 15 which is connected with the processing module 12 is used for, if the current fault event is not found in the fault events pre-stored in the desktop server, dividing the current fault event into a corresponding fault priority according to the demands of the user.

The storage module 16 which is connected with the dividing module 15 is used for storing the current fault event which is not found in the fault events pre-stored in the desktop server.

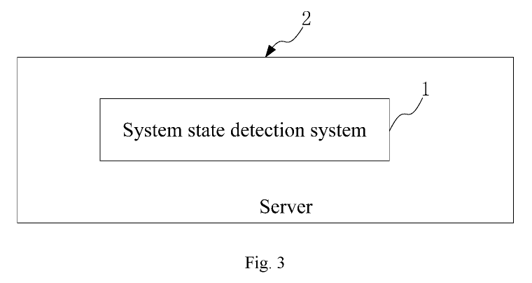

This embodiment further provides a server 2. Please refer to FIG. 3, which illustrates a principle and structure schematic diagram of a server of the invention in one embodiment. As shown in FIG. 3, the server 2 comprises the system state detection system 1. In this embodiment, the functions of the system state detection system 1 are realized through a complex programmable logic device (CPLD). Specifically, the server 2 can be a desktop server in this embodiment.

To sum up, the system state detection method and system and the server provided by the invention do not need to use the BMC chip to support the display of state information, realize the detection of the entire system state, tell the position of the problem to the user or the tester through different colors of health lamps and how to solve it, thus greatly improve the system working efficiency and satisfy the demands of various customers. Therefore, the invention effectively overcomes various disadvantages in the prior art and has a great industrial utilization value.

The above-mentioned embodiments are just used for exemplarily describing the principle and effects of the invention instead of limiting the invention. One skilled in the art can make modifications or changes to the above-mentioned embodiments without going against the spirit and the range of the invention. Therefore, all equivalent modifications or changes made by those who have common knowledge in the art without departing from the spirit and technical concept disclosed by the invention shall be still covered by the claims of the invention.

1. A system state detection method, wherein the system state detection method is applied to a desktop server and comprises the following steps:
reading a current fault event related to a system state through a complex programmable logic device;
judging whether the current fault event has already been pre-stored in the desktop server or not through the complex programmable logic device; if so, executing a next step; and if not, dividing the current fault event into a corresponding fault priority; and
searching a fault priority corresponding to the current fault event through the complex programmable logic device, and lighting up an LED health lamp matched with the corresponding fault priority in a preset alarming manner according to the corresponding fault priority.

2. The system state detection method according to claim 1, wherein:
the fault priority comprises:
a first fault priority including faults which are related to system state powering-on;
a second fault priority including faults which occur during operation of system processes;
a third fault priority including faults which are related to system hardware heat dissipation and cause system shutdown; and
a fourth fault priority including faults which are related to system hardware heat dissipation and in which a system still keeps on operating.

3. The system state detection method according to claim 2, wherein:
fault events corresponding to the first fault priority comprise:
an internal memory power supply fault event, a processor power supply fault event and/or a processor power supply control error fault event; and
when one or more of fault events corresponding to the first fault priority occur, a red lamp of the LED health lamps flashes at frequency of 4 Hz.

4. The system state detection method according to claim 2, wherein:
fault events corresponding to the second fault priority comprise:
fault events related to processor reports and the system processes; and
when the fault events related to the processor reports and the system processes occur, the red lamp of the LED health lamps is normally lighted up.

5. The system state detection method according to claim 2, wherein:
fault events corresponding to the third fault priority comprise: a system fan fault event, a system temperature sensor overheating fault event and/or a processor primary overheating fault event; and
when one or more of the fault events corresponding to the third fault priority occur, a yellow lamp of the LED health lamps flashes at frequency of 1 Hz.

6. The system state detection method according to claim 2, wherein:
fault events corresponding to the fourth fault priority comprise: a processor power supply overheating fault event and/or a processor secondary overheating fault event; and
when one or more of the fault events corresponding to the fourth fault priority occur, the yellow lamp of the LED health lamps is normally lighted up.

7. A system state detection system, wherein the system state detection system is applied to a desktop server and comprises:
a reading module, used for reading a current fault event related to a system state;
a processing module, connected with the reading module and used for judging whether the current fault event has already been pre-stored in the desktop server or not; if so, calling a searching module for searching a fault priority corresponding to the current fault event and an operation module for lighting up an LED health lamp matched with the corresponding fault priority in a preset alarming manner according to the corresponding fault priority; and if not, calling a dividing module for dividing the current fault event into the corresponding fault priority.

8. The system state detection system according to claim 7, wherein the system state detection system further comprises a storage module connected with the dividing module, and the storage module is used for storing the current fault event after the current fault event is divided into the corresponding fault priority.

9. A server, wherein the server comprises:
the system state detection system according to claim 7.

10. The server according to claim 9, wherein the server is a desktop server.

11. A server, wherein the server comprises:
the system state detection system according to claim 8.

12. The server according to claim 11, wherein the server is a desktop server.
